(19) United States
(12) Patent Application Publication
(10) Pub. No.: US 2010/0072956 A1
(43) Pub. Date: Mar. 25, 2010

(54) Low Power and Accurate Adapter-Current Detection Scheme for Dynamic Load Balancing

(76) Inventors: Greg R. Fiebrich, Georgetown, TX (US); Ayedin Nikazm, Austin, TX (US); Shreya Shah, Austin, TX (US)

Correspondence Address: HAMILTON & TERRILE, LLP, P.O. BOX 203518, AUSTIN, TX, 78720, US

(21) Appl. No.: 12/236,634

(22) Filed: Sep. 24, 2008

(51) Int. Cl. H02J 7/04

(52) U.S. Cl. 320/162

(57) ABSTRACT

A charger provides a charging current to an information handling system battery by measuring current provided from an external power source using a Hall sensor. The Hall sensor is integrated into an integrated circuit of the charger to measure current provided by an external power source and output a voltage proportional to the measured current. The charger analyzes the external power source current relative to an available current to determine the charging current. The Hall sensor provides the total current from the charger with minimal resistance to reduce power consumption at the charger.

### BACKGROUND OF THE INVENTION

1. Field of the Invention

The present invention relates in general to the field of information handling system power supply, and more particularly to a system and method for information handling system dynamic load balancing.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems have a variety of electrical components that operate using direct current (DC). Typically, an information handling system power subsystem converts an alternating current (AC) power source, such as a standard wall socket, into a DC source for use by the electrical components. Portable information handling systems typically have an external AC adapter, which converts AC power to DC and provides the DC power through a cable that couples at the housing of the information handling system. Portable information handling systems also typically have an integrated battery, which provides power when the external AC adapter is not connected. As long as the battery has an adequate charge, the portable information handling system operates in much the same manner on battery power as on external power. However, when the battery discharges, the end user typically must provide external power to the electronic components or the system will shut down. Once external power is applied, the information handling system uses the external power to power the electrical components and uses any excess power to charge the battery. For the convenience of end users, information handling system manufacturers typically try to extend the time that the information handling system will operate on battery power as much as possible. Charge life of a battery depends on the size of the battery and the amount of current drawn by the electrical components.

In order to charge an information handling system battery when an external adapter is connected and the system is powered up, a charger integrated in the information handling system determines the amount of excess power that remains after power is supplied to the electrical components and applies that excess power to charge the battery. Portable information handling system chargers typically determine the amount of excess power to apply to charging the battery with an operational amplifier that differentially senses total current from the AC adapter using a current sense resistor. For example, a 10 mOhm resistor is disposed along the wire that carries current to the power subsystem from the AC adapter so that the operational amplifier compares the voltage before and after the current passes through the resistor. The drop in voltage across the resistor provides a basis for determining the total current so that current may be dynamically distributed to charge the battery as power demands of the information handling system components change. One problem with using a current sense resistor is that power is dissipated across the resistor. Although the resistance and resulting power dissipation are relatively small, over time, such as the charge life of a battery, the power dissipation can become significant. For instance, a 230 Watt adapter providing a maximum current of 11.8 Amps will have a continuous power dissipation of 1.39 Watts. Another difficulty is that current readings using a current sense resistor are sometimes inaccurate. For instance, sensing traces are sometimes routed through multiple layers of a circuit board causing the operational amplifier to read inaccurate voltage levels, thus disrupting distribution of current between system load demands and charging of the battery. Another difficulty is that high power consumption systems are sometimes driven to use lower current sense resistors resulting in less accurate total current readings when the load current is low.

### SUMMARY OF THE INVENTION

Therefore a need has arisen for a system and method which determines an information handling system charging current with minimal impact on the operation of the information handling system.

In accordance with the present invention, a system and method are provided which substantially reduce the disadvantages and problems associated with previous methods and systems for determining an information handling system charging current. An information handling system charger has a Hall sensor that determines current applied to the information handling system. Analysis of the determined current allows a determination of a charging current for charging a battery of the information handling system.

More specifically, an information handling system has plural electronic components that are powered by either a battery integrated with the information handling system or an external power source. During operation of the information handling system on the external power source, a charger determines excess current available from the external power source after the electronic components are powered and applies the excess current to charge the battery. The charger includes an integrated circuit have a controller with logic to determine the charging current and a Hall sensor integrated in the integrated circuit to determine the total current used to power the electronic components. The Hall sensor provides a voltage proportional to the total current, which the charger logic applies to determine the charging current. The Hall sensor alters the proportional voltage as the total current changes so that the charger can dynamically alter the charging current to use excess current available from the external power source without exceeding the capability of the external power source.

The present invention provides a number of important technical advantages. One example of an important technical advantage is that sensing current with a Hall device has a reduced impact on system operation when compared with the impact caused by a current sense resistor. For example, the Hall device that determines total current has less resistance and thus dissipates less power than sense resisters used in conventional systems. In the example system having a 230 Watt AC adapter that draws 11.8 Amps, power dissipation is approximately 0.209 Watts, 1.109 Watts less than in a sense resistor system. Since total current feeds directly into the Hall sensor integrated in the charger, routing of the wire lines adds minimal resistance compared with routing done to support a sense resistor outside of the charger. The Hall sensor provides accurate readings even for relatively high power adapters, such as 230 Watt adapters.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts a block diagram of an information handling system having a charger that measures current with a Hall sensor.

### DETAILED DESCRIPTION

An information handling system charger determines charging current for charging a battery by measuring current provided from an external power source with a Hall sensor. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

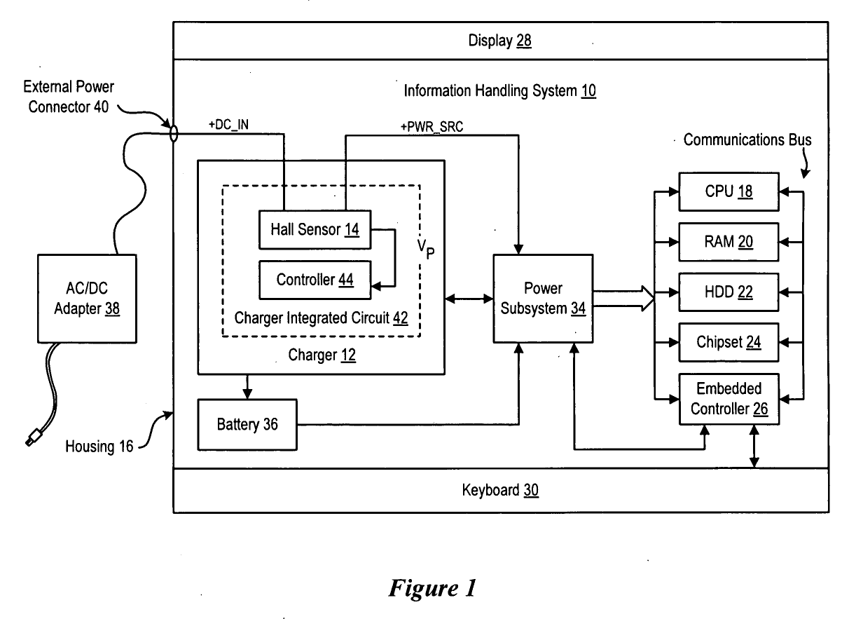

Referring now to FIG. 1, a block diagram depicts an information handling system 10 having a charger 12 that measures current with a Hall sensor 14. Information handling system 10 is built with a plurality of processing components disposed in a housing 16, such as a CPU 18, RAM 20, a hard disk drive 22, a chipset 24 and an embedded controller 26. The processing components cooperate to performing processing activities, such as running applications for presentation of information at an integrated display 28 based on inputs made through a keyboard 30. In order to perform processing operations, a power rail provides electrical power to the processing components. Electrical power is provided to the processing components with a power subsystem 34 that receives electrical power from either an integrated battery 36 or an external power source, such as an AC to DC adapter interfaced at an external power connector 40 of the housing 16. The application of power to the processing components is managed with logic running on a processing component, such as embedded controller 26 or a microcontroller within power subsystem 34. Power consumption by the processing components may vary considerably as electrical components are power down, powered up or placed in different types of reduced power states. Power subsystem 34 applies different amounts of current to meet electrical component load demands as those demands change over time.

Integration of battery 36 within housing 16 provides the end user with flexibility to operate information handling system 10 free from an external connection that applies power, such as a power socket. However, battery 36 has a limited charge life and needs periodic recharging to keeping information handling system 10 running. Once AC-to-DC adapter 38 couples to external power connector 40, power subsystem 34 switches from pulling current from battery 36 to instead pull current from AC-to-DC adapter 38. Power subsystem 34 draws varying amounts of current from the external power source depending upon the load of the electrical components. Charger 12 compares the load current drawn by power subsystem 34 with the available current from AC-to-DC adapter 38 and uses available excess power to recharge battery 36. Charger 12 analyzes variations in the load drawn by power subsystem 34 to power the processing components and applies the analysis to dynamically adjust current applied to recharge battery 36. In various embodiments, various portions of logic to supply power to the electronic components may be performed with logic running on one or more processing components, such as CPU 18, embedded controller 26 or a microcontroller on power subsystem 34.

In order to determine the amount of current for use in recharging battery 36, charger 12 has a charger integrated circuit 42 that includes a controller 44 and Hall sensor 14. Hall sensor 14 is a sensor that uses the Hall effect to measure current through power line +DC_IN, which provides power from AC-to-DC adapter 38. Hall sensor 14 provides a voltage Vp which is proportional to the current passing through +DC_IN. Controller 44 analyzes the proportional voltage to determine the total current provided by +DC_IN, and sets current to recharge battery 36 so that the maximum output of AC-to-DC adapter 38 will not be exceeded. Controller 44 dynamically adjusts the charging current as the total current varies so that a charge current is maintained at battery 36 without exceeding the output of AC-to-DC adapter 38. Hall sensor 14 has minimal resistance so that minimal power is consumed by the measurement of total current. A conventional current sense resistor, which would run between +DC_IN and +PWR_SRC, typically resides outside of charger 12, thus adding resistance and impedance with wires used to route the inbound power. In contrast, Hall sensor 14 is integrated into integrated circuit 42 for minimal interference with the inbound current. In various embodiments, different types of logic may apply to analyze the total current measured by Hall sensor 14 and determine a charging current. For instance, controller 44 may apply a charging current so that the total current measured by Hall sensor 14 represents both the load current and the charging current with the total current set at a value at or below the maximum current available from AC-to-DC adapter 38. As another example, total current measures the load of the electrical components so that total current is subtracted from the maximum current available from AC-to-DC adapter 38 to provide the charging current.

Although the present invention has been described in detail, it should be understood that various changes, substitutions and alterations can be made hereto without departing from the spirit and scope of the invention as defined by the appended claims.

What is claimed is:

1. An information handling system comprising:
a housing;
plural electrical components disposed in the housing and operable to process information;
a power subsystem operable to power the electrical components from an external power source or a battery disposed in the housing; and
a charger interfaced with the power subsystem, the charger operable to determine a charging current for charging the battery from a total current provided from the external power source; and
a Hall sensor associated with the charger, the Hall sensor operable to determine the total current provided from the external power source for use by the charger.

2. The information handling system of claim 1 wherein the Hall sensor is integrated into the charger.

3. The information handling system of claim 2 wherein the Hall sensor outputs a voltage proportional to the total current provided from the external power source.

4. The information handling system of claim 2 further comprising a battery operable to selectively discharge to power the electrical components or recharge from the external power source.

5. The information handling system of claim 2 wherein the charger determines the charging current by analyzing system load demands and the total current provided by the external power source.

6. The information handling system of claim 5 wherein the external power source comprises an AC-to-DC adapter.

7. The information handling system of claim 5 wherein system load demands comprise current drawn by the electrical components.

8. The information handling system of claim 7 wherein the charger comprises an integrated circuit and wherein the Hall sensor is integrated with the integrated circuit.

9. A method for dynamically allocating a charging current to charge a battery, the method comprising:
measuring total current provided from an external power source by passing the total current proximate a Hall sensor;
analyzing the total current relative to a load demand of one or more electrical components; and
providing a charging current to a battery based upon analyzing the total current relative to a load demand.

10. The method of claim 9 wherein the load demand comprises current drawn by the electrical components.

11. The method of claim 9 wherein measuring total current further comprises measuring total current with a charger, the charger interfaced with the battery.

12. The method of claim 11 wherein the charger comprises an integrated circuit.

13. The method of claim 12 wherein the Hall sensor is integrated in the integrated circuit.

14. The method of claim 12 wherein measuring the total current further comprise outputting a voltage from the Hall sensor that is proportional to the total current.

15. The method of claim 14 wherein 9 wherein the electrical components comprise processing components of an information handling system, the processing components integrated in a housing with the battery.

16. A system for dynamically allocating a charging current to charge a battery, the system comprising:
a charger operable to apply the charging current to the battery from an external power source having a total current;
a Hall sensor operable to determine the total current; and
charging logic associated with the charger and interfaced with the Hall sensor, the charging logic operable to determine the charging current by reference to the total current determined by the Hall sensor.

17. The system of claim 16 wherein the charger comprises an integrated circuit.

18. The system of claim 17 wherein the Hall sensor is integrated in the integrated circuit.

19. The system of claim 18 wherein the charging current is achieved by setting the charging current so that the total current comprises a predetermined available current.
